(19) United States
(12) Patent Application Publication
(10) Pub. No.: US 2026/0287419 A1
(43) Pub. Date: Sep. 24, 2026

(54) STATE MONITORING METHOD, STATE MONITORING DEVICE, AND PROGRAM FOR MECHANICAL DEVICE

(71) Applicant: NSK Ltd., Tokyo (JP)

(72) Inventor: Kazuto NISHIZAWA, Kanagawa (JP)

(73) Assignee: NSK Ltd., Tokyo (JP)

(21) Appl. No.: 19/479,869

(22) PCT Filed: Mar. 18, 2025
(86) PCT No.: PCT/JP2025/010444

§ 371 Date: Oct. 29, 2025

(30) Foreign Application Priority Data
Mar. 29, 2024 (JP) 2024-056324

(51) Int. Cl. G01H 1/00; G01M 13/045

(52) U.S. Cl. CPC G01H 1/003; G01M 13/045

(57) ABSTRACT

A state monitoring method for a mechanical device, performing a rotation operation, includes: an acquisition step of acquiring rotational speed data and vibration data during the rotation operation of the mechanical device; a conversion step of converting the vibration data from a time domain to an angle domain using the acquired rotational speed data and the acquired vibration data; a reconversion step of reconverting the converted vibration data into a time domain based on a predetermined reference speed; and a diagnosis step of diagnosing a state of the mechanical device using the converted vibration data, in which in the conversion step, when the rotational speed data includes a section in which a rotational speed is zero or substantially equal to zero, the rotational speed data is corrected such that the rotational speed fluctuates in the section, and then the vibration data is converted into an angle domain.

### TECHNICAL FIELD

The present invention relates to a state monitoring method, a state monitoring device, and a program for a mechanical device.

### BACKGROUND ART

In the related art, in order to appropriately operate a mechanical device, states of various components constituting the mechanical device are monitored. The mechanical device includes, for example, a bearing for a rotation operation. In order to diagnose a state of the bearing, there is a method of acquiring vibration information during operation and analyzing the vibration information.

For example, Patent Literature 1 discloses a method of detecting a desired frequency spectrum from vibration information by applying an order tracking method in consideration of a change in a rotational speed of a bearing and using the frequency spectrum for abnormality diagnosis.

### CITATION LIST

### Patent Literature

Patent Literature 1: JP2023-75685A

### SUMMARY OF INVENTION

### Technical Problem

As described in Patent Literature 1, use of the order tracking method allows a desired frequency spectrum to be specified even when there is a change in the rotational speed of the bearing. On the other hand, the rotational speed may temporarily become zero or close to zero in the rotation operation of the bearing. In such a state, a feature of the vibration information cannot be captured by the method described in Patent Literature 1. Therefore, the method described in Patent Literature 1 cannot be used as it is for a bearing in which such a state may occur.

In view of the above problems, an object of the present invention is to accurately monitor a state of a mechanical device even when a change in a rotational speed including stop of rotation occurs in an environment in which the rotational speed in a rotation operation of the mechanical device may change intermittently.

### Solution to Problem

In order to solve the above problems, the present invention has the following configuration. That is, a state monitoring method for a mechanical device that performs a rotation operation, the state monitoring method including:
an acquisition step of acquiring rotational speed data and vibration data during the rotation operation of the mechanical device;
a conversion step of converting the vibration data from a time domain to an angle domain using the rotational speed data and the vibration data acquired in the acquisition step;
a reconversion step of reconverting the vibration data converted in the conversion step into a time domain based on a predetermined reference speed; and
a diagnosis step of diagnosing a state of the mechanical device using the vibration data converted in the reconversion step, in which
in the conversion step, when the rotational speed data includes a section in which a rotational speed is zero or substantially equal to zero, the rotational speed data is corrected such that the rotational speed fluctuates in the section, and then the vibration data is converted into an angle domain.

Another aspect of the present invention has the following configuration. That is, a state monitoring device for a mechanical device that performs a rotation operation, the state monitoring device including:
an acquisition unit configured to acquire rotational speed data and vibration data during the rotation operation of the mechanical device;
a conversion unit configured to convert the vibration data from a time domain to an angle domain using the rotational speed data and the vibration data acquired by the acquisition unit;
a reconversion unit configured to reconvert the vibration data converted by the conversion unit into a time domain based on a predetermined reference speed; and
a diagnosis unit configured to diagnose a state of the mechanical device using the vibration data converted by the reconversion unit, in which
when the rotational speed data includes a section in which a rotational speed is zero or substantially equal to zero, the conversion unit corrects the rotational speed data such that the rotational speed fluctuates in the section, and then converts the vibration data into an angle domain.

Another aspect of the present invention has the following configuration. That is, a program that causes a computer to execute:
an acquisition step of acquiring rotational speed data and vibration data during a rotation operation of a mechanical device;
a conversion step of converting the vibration data from a time domain to an angle domain using the rotational speed data and the vibration data acquired in the acquisition step;
a reconversion step of reconverting the vibration data converted in the conversion step into a time domain based on a predetermined reference speed; and
a diagnosis step of diagnosing a state of the mechanical device using the vibration data converted in the reconversion step, in which
in the conversion step, when the rotational speed data includes a section in which a rotational speed is zero or substantially equal to zero, the rotational speed data is corrected such that the rotational speed fluctuates in the section, and then the vibration data is converted into an angle domain.

### Advantageous Effects of Invention

According to the present invention, it is possible to accurately monitor a state of a mechanical device even when a change in a rotational speed including stop of rotation occurs in an environment in which the rotational speed in a rotation operation of the mechanical device may change intermittently.

### BRIEF DESCRIPTION OF DRAWINGS

FIG. 1 is a schematic diagram illustrating an example of a functional configuration according to an embodiment of the present invention.

FIGS. 2A to 2D are graphs illustrating data conversion according to the embodiment of the present invention.

FIG. 3 is a flowchart of state monitoring processing according to the embodiment of the present invention.

FIG. 4A is a graph illustrating an example of a rotational speed of a bearing.

FIG. 4B is a graph illustrating an example of vibration data generated in the bearing.

FIG. 4C is a graph illustrating an example in which the vibration data is converted into an angle domain.

FIG. 4D is a graph illustrating an example in which the vibration data of the angle domain is converted into a time domain.

FIG. 4E is a graph illustrating an example of a result of applying envelope FFT processing to the vibration data.

FIGS. 5A to 5C are graphs illustrating a flow of conversion of the vibration data according to the present embodiment.

FIG. 6 is a graph illustrating a problem handled in the present embodiment.

FIGS. 7A to 7C are graphs illustrating a flow of conversion of the vibration data according to the present embodiment.

FIG. 8 is a graph illustrating an example of the rotational speed according to the present embodiment.

FIGS. 9A to 9C are graphs illustrating an example of a processing result of state monitoring processing according to the present embodiment.

FIGS. 10A to 10C are graphs illustrating an example of the processing result of the state monitoring processing according to the present embodiment.

FIGS. 11A to 11C are graphs illustrating an example of the processing result of the state monitoring processing according to the present embodiment.

### DESCRIPTION OF EMBODIMENTS

Hereinafter, embodiments of the present invention will be described with reference to the drawings. The embodiments described below are embodiments for explaining the present invention, and are not intended to be interpreted to limit the present invention, and all the configurations described in the embodiments are not necessarily essential configurations for solving the problem of the present invention. In the drawings, the same components are denoted by the same reference numerals, thereby showing a correspondence relation therebetween.

### First Embodiment

Hereinafter, a first embodiment of the present invention will be described. A method according to the present embodiment is applicable to a bearing that operates at a low rotational frequency lower than a certain rotational frequency, or a bearing having a large variation in rotational frequency, such as a rolling bearing. A type of a mechanical device as a bearing device including a bearing is not particularly limited.

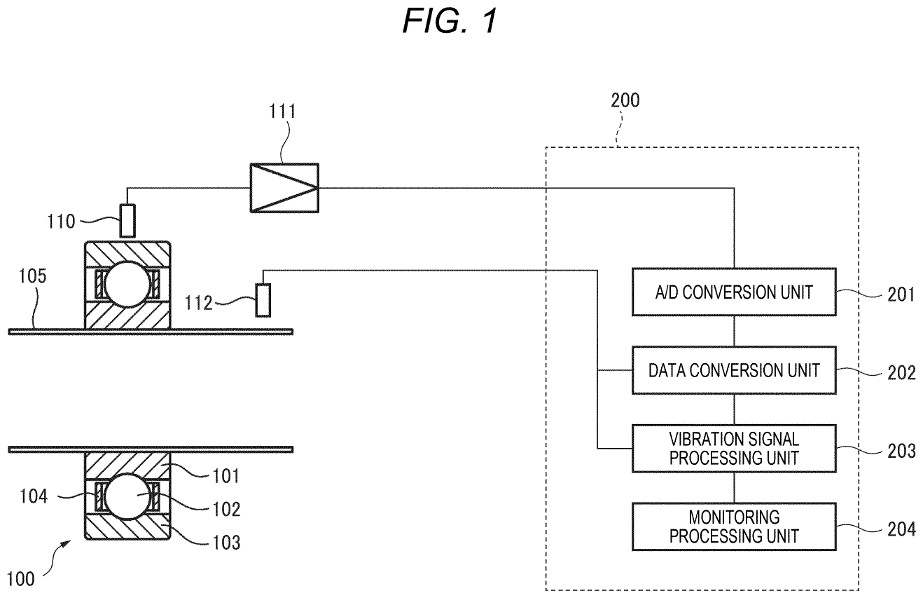

FIG. 1 is a schematic diagram illustrating an example of a functional configuration according to the present embodiment. FIG. 1 illustrates configurations of a rolling bearing 100 to be monitored and a monitoring device 200 that performs state monitoring processing according to the present embodiment. The rolling bearing 100 is provided in a bearing device and rotatably supports a main shaft 105. In the present embodiment, the rolling bearing 100 may be applied to, for example, a tapered roller bearing or a cylindrical roller bearing, but the present invention is not limited thereto.

The monitoring device 200 may be provided integrally with a mechanical device (not illustrated) provided with the rolling bearing 100, or may be provided outside the mechanical device. In FIG. 1, for simplification of description, a configuration in which one monitoring device 200 monitors one rolling bearing 100 is illustrated. However, the present invention is not limited to this configuration, and one monitoring device 200 may monitor states of a plurality of rolling bearings 100.

The rolling bearing 100 includes an inner ring 101 which is a rotating ring externally fitted to the main shaft 105, an outer ring 103 which is a fixed ring internally fitted to a housing (not illustrated), a plurality of balls (rollers) which are a plurality of rolling bodies 102 disposed between the inner ring 101 and the outer ring 103, and a cage 104 that holds the rolling bodies 102 such that the rolling bodies 102 can roll freely. In the rolling bearing 100, friction between the inner ring 101 and the rolling element 102 as well as friction between the outer ring 103 and the rolling element 102 are reduced by a predetermined lubrication method. A lubrication method is not particularly limited, and for example, grease lubrication or oil lubrication is used. A type of a lubricant is also not particularly limited.

A vibration sensor 110 is provided to detect vibration generated from the rolling bearing 100 during rotation of the main shaft 105. The vibration sensor 110 is fixed to the vicinity of the outer ring of the housing by bolt fixation, adhesion, bolt fixation and adhesion, embedding with a molding material, or the like. In a case of the bolt fixation, a rotation prevention function may be provided. The vibration sensor 110 is not limited to being fixedly installed at a detection position, and may be installed at a position for detecting the vibration due to the rolling bearing 100 during state monitoring. Therefore, the vibration sensor 110 may be detachable or movable.

The vibration sensor 110 may be any sensor capable of detecting vibration, and may be any sensor capable of converting detected vibration such as an acceleration, a speed, a strain, a stress, or a displacement to an electric signal, such as an acceleration sensor, an acoustic emission (AE) sensor, an ultrasonic sensor, and a shock pulse sensor. In addition, at the time of being attached to a mechanical device located in an environment where the noise is large, it is more preferable to use an insulation-type sensor because it is less affected by noise. Further, in a case in which the vibration sensor 110 uses a vibration detection element such as a piezoelectric element, the element may be implemented by being molded in plastic or the like.

The rolling bearing 100 is provided with a rotational speed sensor 112 that detects a rotational speed of the inner ring 101 externally fitted to the main shaft 105. In the present embodiment, the rotational speed and the rotational frequency of the inner ring 101, which is a rotating ring, and the main shaft 105 match with each other. The rotational speed of the main shaft 105 may vary depending on an external cause or a control command to the mechanical device. Further, the rotational speed may be adjusted by a brake device (not illustrated). The rotational speed sensor 112 may detect the rotational speed of the rolling bearing 100 by detecting an encoder (not illustrated) provided at the inner ring 101 of the rolling bearing 100, for example. The rotational speed sensor 112 according to the present embodiment is capable of detecting a change in the rotational speed during one rotation of the rolling bearing 100. The vibration sensor 110 and the rotational speed sensor 112 may perform the detection operation only at specified timings (for example, monitoring time periods), or may perform the detection operation at all times.

An amplifier 111 amplifies the electric signal detected by the vibration sensor 110 and inputs the amplified electric signal to the monitoring device 200. A degree of amplification here is not particularly limited, but is defined in advance. Detection timings of the vibration sensor 110 and the rotational speed sensor 112 correspond to each other, and detection information thereof are processed in association with each other.

The monitoring device 200 may be implemented by, for example, an information processing device including a control device (not illustrated), a storage device (not illustrated), and an input/output device (not illustrated). The control device may include a central processing unit (CPU), a micro processing unit (MPU), a digital single processor (DSP), or a dedicated circuit. The storage device includes volatile and non-volatile storage media such as a hard disk drive (HDD), a read only memory (ROM), and a random access memory (RAM), and may input and output various types of information in response to instructions from the control device. The input/output device notifies an external device or an operator according to the instructions from the control device. An output method by the input/output device is not particularly limited, and may be, for example, an auditory notification by voice or a visual notification by screen output. The input/output device may be a network interface having a communication function, and may perform various input/output operations by transmitting data to and receiving data from an external device (not illustrated) via a network (not illustrated).

The monitoring device 200 includes an A/D conversion unit 201, a data conversion unit 202, a vibration signal processing unit 203, and a monitoring processing unit 204. Each unit may be implemented by the above-described control device reading a corresponding program from the storage device and executing the program. Further, various functions may be implemented by the control device controlling the input/output device.

The A/D conversion unit 201 acquires the electric signal detected by the vibration sensor 110 as vibration information via the amplifier 111, and performs analog/digital (A/D) conversion according to a content of the electric signal.

The data conversion unit 202 performs conversion processing on data used for processing of the vibration signal processing unit 203 and the monitoring processing unit 204 in the latter stage from the vibration signal processed by the A/D conversion unit 201, based on the rotational speed detected by the rotational speed sensor 112. An example of the conversion processing will be described later. The converted data is output to the vibration signal processing unit 203.

The vibration signal processing unit 203 performs signal analysis processing using the data output from the data conversion unit 202. In the signal analysis processing, fast Fourier transform (FFT) analysis is performed, and then order ratio analysis is performed. The signal analysis processing may be performed by performing envelope processing, or filter processing using a low-pass filter, a band-pass filter, or the like.

The monitoring processing unit 204 diagnoses a state of the rolling bearing 100 using the data processed by the vibration signal processing unit 203, and outputs a diagnosis result. For example, a part of the data processed by the vibration signal processing unit 203 may be extracted, and the state may be diagnosed using the data. Diagnosis items of state monitoring performed by the monitoring processing unit 204 are not particularly limited, and for example, any diagnosis item such as rotation slip, revolution slip, abnormal contact, poor lubrication, damage or deterioration of portions constituting the rolling bearing 100 may be a target.

A monitoring result of the monitoring processing unit 204 may be notified to the outside via the network (not illustrated), or may control an operation of the mechanical device.

### [Conversion of Vibration Data]

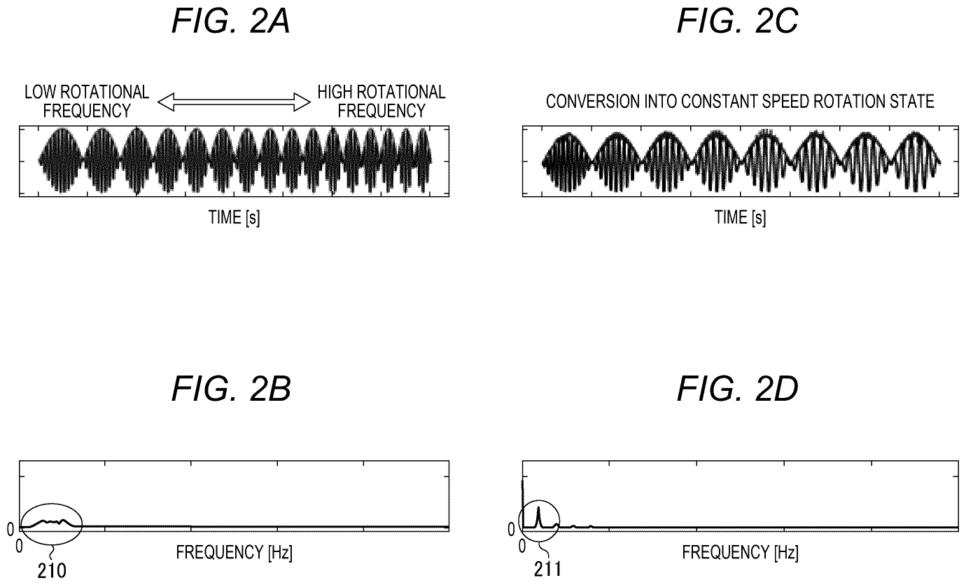

Conversion of the vibration data according to the present embodiment will be described. The graphs of FIGS. 2A to 2D and FIGS. 4A to 8B described later are examples provided to describe the present embodiment. FIGS. 2A to 2D are diagrams illustrating the conversion of the vibration data according to the present embodiment. FIG. 2A illustrates an example of vibration data A obtained from a measurement target via the vibration sensor 110. In FIG. 2A, the horizontal axis represents time [s], and the vertical axis represents an amplitude. Actual vibration data of a bearing is data in which different vibrations with many different frequencies are superimposed, but the vibration data A here will be described using an example in which only two pieces of vibration data B and C are included. In the example illustrated in FIG. 2A, an angular velocity of a rolling bearing increases over time, and the rotational frequency increases in proportion to the angular velocity. As a result, a frequency of the vibration data C of the two pieces of vibration data B and C gradually increases over time, and a waveform of the entire vibration data A illustrated in FIG. 2A also changes. In FIG. 2A, an envelope illustrated on an upper side of the vibration data corresponds to a waveform indicating a result of envelope processing. The rotational frequency is not limited to the fluctuation as illustrated in FIG. 2A, and may change to decrease over time, or may increase or decrease within a certain period of time.

FIG. 2B illustrates a result obtained by applying the envelope processing and fast Fourier transform (FFT) processing to the waveform illustrated in FIG. 2A. In FIG. 2B, the horizontal axis represents a frequency [Hz], and the vertical axis represents an intensity. At this time, a frequency peak cannot be detected as illustrated in a region 210 of FIG. 2B due to the fluctuation of the rotational frequency in the vibration data C. Therefore, it is impossible to specify frequency characteristics of the vibration data C, and analysis based on the frequency characteristics becomes difficult.

For example, frequency analysis is used at the time of monitoring the state of the rolling bearing. A natural frequency of vibration of the rolling bearing is proportional to the angular velocity during rotation, and in the frequency analysis, it is necessary to use data in a state in which the rolling bearing rotates at a constant speed. However, there may be a case where the angular velocity fluctuates during one rotation of the rolling bearing and a frequency of vibration changes. In the present embodiment, vibration data sampled at equal time intervals in a state in which the angular velocity fluctuates is converted into vibration data corresponding to a state in which the angular velocity is constant, that is, the rotation is performed at a uniform speed.

FIG. 2C illustrates an example of vibration data D obtained by applying processing of removing the influence of the fluctuation of the rotational frequency according to the present embodiment to the vibration data A illustrated in FIG. 2A. In FIG. 2C, the horizontal axis represents the time [s], and the vertical axis represents the amplitude. In FIG. 2C, the vibration data A in FIG. 2A is converted into vibration data corresponding to a state in which the angular velocity is constant, that is, the rotation is performed at a uniform speed.

In the conversion method according to the present embodiment, first, to satisfying the following formula (1) is obtained using original vibration data and a predetermined angular velocity. The predetermined angular velocity here is described as an initial angular velocity ω₀ in the vibration data, but the present invention is not limited thereto. For example, the predetermined angular velocity may be an average value or a maximum value of angular velocities within a predetermined range of the vibration data. In addition, the predetermined angular velocity may be an angular velocity at a predetermined timing of the vibration data.

$$[ Math . 1 ]$$

$${ω}_{0} \times {t}_{1} = {\int }_{0}^{{t}_{0}} ω ( t ) dt \qquad ( 1 )$$

ω₀: initial angular velocity
ω(t): angular velocity at time t
t₀: time (initial time in vibration data as processing target being set to zero)
t₁: time

Further, the vibration data A before conversion and the vibration data D after conversion are converted according to the following formula (2).

$$D ( {t}_{1} ) = A ( {t}_{0} ) \qquad ( 2 )$$

A(t): vibration data before conversion at time t
D(t): vibration data after conversion at time t

By the conversion using the above formulas (1) and (2), the vibration data D illustrated in FIG. 2C is obtained. That is, the vibration data D corresponds to waveform data in a state in which the angular velocity is a constant angular velocity (here, initial angular velocity ω₀). In FIG. 2C, an envelope illustrated on an upper side of the vibration data D corresponds to a waveform indicating the result of the envelope processing.

FIG. 2D illustrates a result of applying the envelope processing and FFT processing to the waveform illustrated in FIG. 2C. In FIG. 2D, the horizontal axis represents the frequency [Hz], and the vertical axis represents the intensity. At this time, because of a waveform in which the rotational frequency is assumed to be constant, a frequency peak can be detected as illustrated in a region 211 of FIG. 2D, and analysis based on frequency characteristics may be performed.

In the above flow, an example is shown in which the data conversion processing, the envelope processing, and the FFT processing are performed on the vibration data in this order, but the present invention is not limited thereto. For example, the envelope processing, the data conversion processing, and the FFT processing may be performed in this order. Alternatively, only the data conversion processing and the FFT processing may be performed without performing the envelope processing.

Since the number of times of sampling for acquiring the vibration data A is limited, vibration data A(t₀) corresponding to time to specified by the above formula (1) may not exist in the vibration data A obtained by the vibration sensor 110 or the like. In such a case, a predetermined range a may be set in advance, and the vibration data D may be obtained using vibration data A(t₀′) corresponding to t₀′ included in the predetermined range with reference to t₀, as in the following formula (3).

$$D ( {t}_{1} ) = A ( {t}_{0}^{′} ) ( {t}_{0} - a < {t}_{0}^{′} < {t}_{0} + a ) \qquad ( 3 )$$

Alternatively, an interpolation formula based on vibration data A(t) corresponding to t (for convenience, t₀−1, t₀+1) before and after to may be defined, such as the following formula (4), and the vibration data D may be obtained.

$$D ( {t}_{1} ) = \{ A ( {t}_{0} - 1 ) + A ( {t}_{0} + 1 ) \} / 2 \qquad ( 4 )$$

As a data interpolation method for data conversion, a method other than the above methods may be used, and the interpolation method to be applied may be switched according to the purpose.

Further, in the present embodiment, processing assuming a case where the rotational speed is zero or close to zero is performed in the conversion of the vibration data described above. Details will be described together with a processing flow and a graph.

### [Processing Flow]

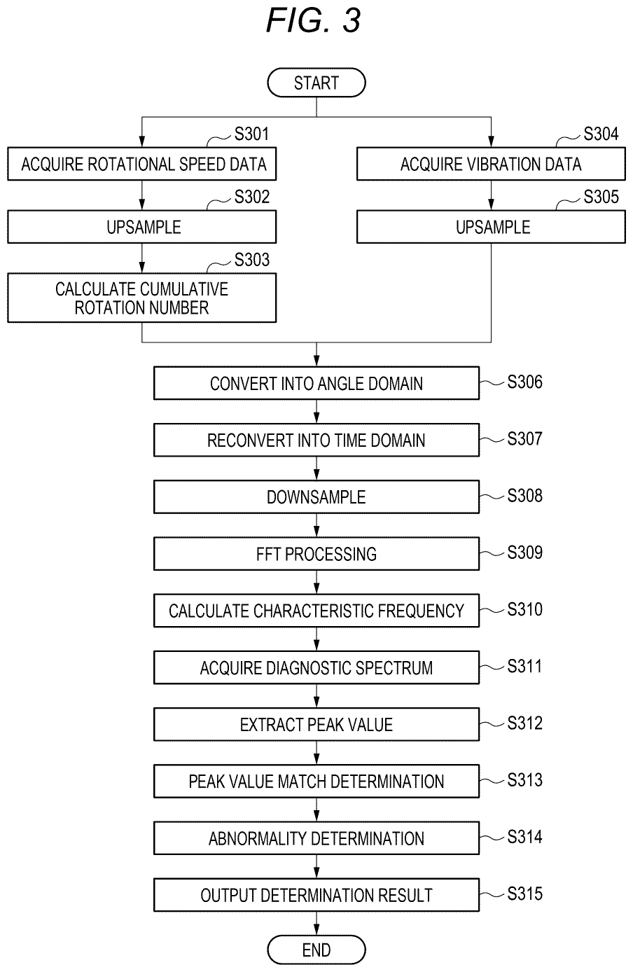

FIG. 3 is a flowchart of diagnosis processing according to the present embodiment. The processing is executed by the monitoring device 200, and may be implemented by, for example, the control device (not illustrated) included in the monitoring device 200 reading out programs for implementing the units illustrated in FIG. 1 from the storage device (not illustrated) and executing the programs.

Steps S301 to S303 and steps S304 and S305 in FIG. 3 are executed simultaneously in parallel. That is, rotational speed data acquired by the rotational speed sensor 112 and the vibration data acquired by the vibration sensor 110 are acquired in time correspondence.

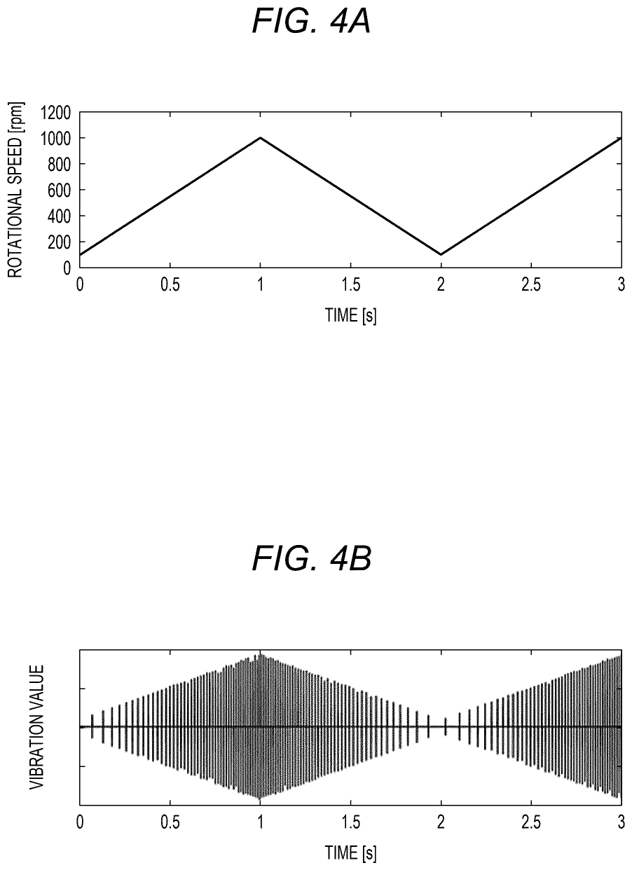

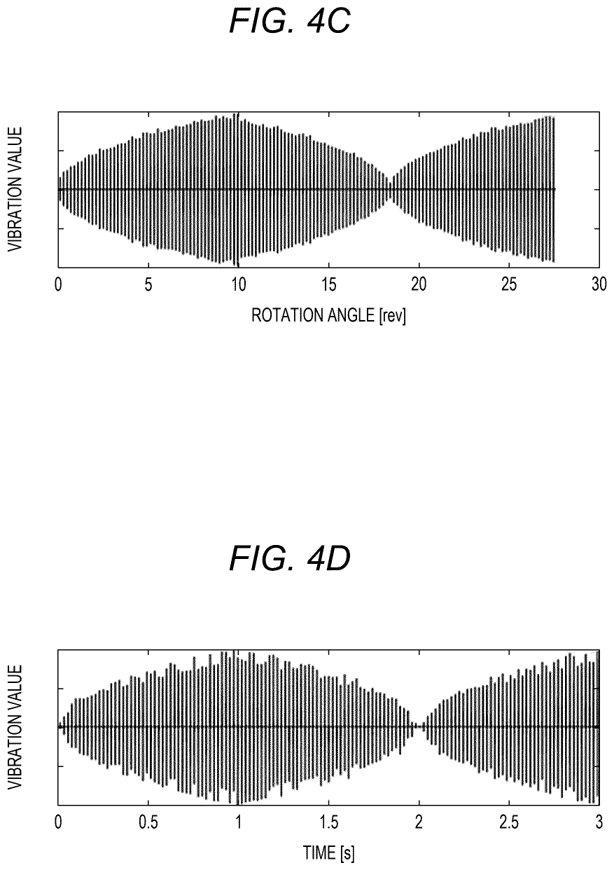

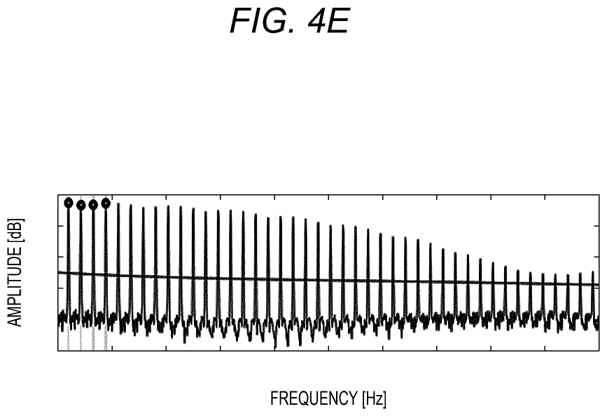

In S301, the monitoring device 200 acquires the rotational speed data of the rolling bearing 100 via the rotational speed sensor 112. FIG. 4A is a graph illustrating an example of the rotational speed data. In FIG. 4A, the horizontal axis represents the rotational speed [rpm], and the vertical axis represents the time [s].

In S302, the monitoring device 200 upsamples the rotational speed data acquired in S301. The upsampling here is performed in order to prevent occurrence of an error or the like at the time of conversion of the vibration data to be described later. The upsampling in S302 may be omitted.

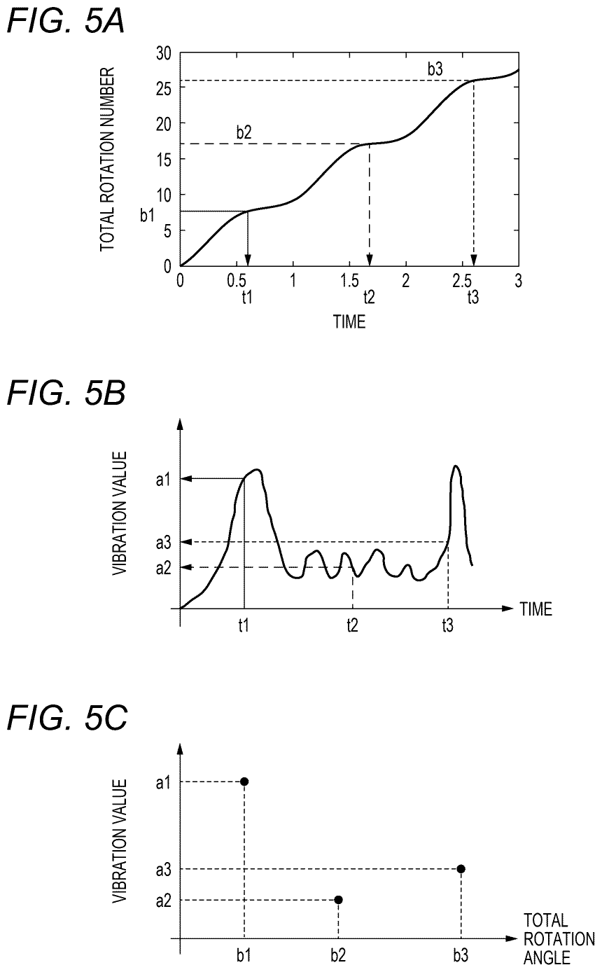

In S303, the monitoring device 200 calculates a cumulative rotation number of the rolling bearing 100 using the data upsampled in S302. An example of the cumulative rotation number will be described later with reference to FIG. 5A.

In S304, the monitoring device 200 acquires the vibration data of the rolling bearing 100 via the vibration sensor 110. FIG. 4B is a graph illustrating an example of the vibration data. In FIG. 4B, the vertical axis represents a vibration value, and the horizontal axis represents time [s].

In step S305, the monitoring device 200 upsamples the vibration data acquired in step S304. The upsampling here is performed in order to prevent occurrence of an error or the like at the time of conversion of the vibration data to be described later. A degree of upsampling is equal to that in step S302. The upsampling in S305 may be omitted.

In S306, the monitoring device 200 converts the vibration data into an angle domain using the cumulative rotation number calculated in S303 and the vibration data upsampled in S305. The conversion method here will be described later. FIG. 4C is a graph illustrating an example in which the vibration data is converted into an angle domain. In FIG. 4C, the vertical axis represents the vibration value, and the horizontal axis represents the angle [rev].

In S307, the monitoring device 200 reconverts the vibration data converted into the angle domain in S306 into a time domain at a reference speed. The reference speed here may be, for example, an average speed of the rolling bearing 100. That is, as illustrated in FIG. 2C, the conversion is performed so as to correspond to a state of constant speed rotation at the reference speed.

In S308, the monitoring device 200 downsamples the vibration data reconverted in S307. Downsampling here corresponds to the upsampling in step S305. FIG. 4D is a graph illustrating an example of the vibration data after downsampling. In FIG. 4D, the vertical axis represents the vibration value, and the horizontal axis represents the time [s]. When upsampling of S302 and S305 is omitted, downsampling of S308 is also omitted.

In S309, the monitoring device 200 applies FFT processing to the vibration data downsampled in S308. The FFT processing may be performed by a known method, and a detailed description thereof is omitted here. In addition to the FFT processing, known envelope processing, filter processing, or the like may be performed. FIG. 4E illustrates an example of data obtained by the FFT processing. In FIG. 4E, the vertical axis represents the amplitude, and the horizontal axis represents the frequency.

In S310, the monitoring device 200 calculates a characteristic frequency corresponding to a portion of the rolling bearing 100 to be monitored.

In S311, the monitoring device 200 acquires a diagnostic spectrum corresponding to the characteristic frequency calculated in S310 from the data obtained by the FFT processing in S309.

In S312, the monitoring device 200 extracts a peak value of the diagnostic spectrum acquired in S311.

In S313, the monitoring device 200 determines whether the peak value extracted in S312 matches the characteristic frequency calculated in S310 and an order thereof.

In S314, the monitoring device 200 determines whether an abnormality occurs in the rolling bearing 100 based on a result of the match determination in S313. For example, when the peak value matches the characteristic frequency and the order thereof, it may be determined that there is an abnormality in a portion corresponding to the characteristic frequency. A diagnosis item here is not limited to presence or absence of an abnormality. For example, any diagnosis item such as rotation slip and revolution slip of the rolling bearing 100, or abnormal contact, poor lubrication, damage or deterioration of portions constituting the rolling bearing 100 may be a target.

In S315, the monitoring device 200 outputs a determination result in S314 as a result of the state monitoring. An output method here is not particularly limited, and the determination result may be visually displayed on a screen, or may be audibly output by a speaker or the like. Alternatively, when it is determined that there is an abnormality, the determination result may be output as a control signal for controlling the operation of the mechanical device. In addition, the determination result may be output to a user or the like at a timing when it is determined that there is an abnormality, or may be output at a predetermined timing. Then, the processing flow ends.

The processing after step S309 illustrated in FIG. 3 may be equivalent to, for example, the method described in Japanese Patent Application Laid-Open No. 2023-75685.

### (Conversion Processing)

Conversion of the vibration data in the abnormality diagnosis method according to the present embodiment will be described. FIGS. 5A to 5C is a graph illustrating conversion of the vibration data based on an order tracking method described with reference to FIGS. 2A to 2D

FIG. 5A is a graph illustrating an example of the cumulative rotation number of the rolling bearing 100. In FIG. 5A, the vertical axis represents a total rotation number, and the horizontal axis represents the time. The total rotation number is obtained by cumulatively integrating the rotational speed obtained by the rotational speed sensor 112.

FIG. 5B is a graph illustrating an example of the vibration data obtained by the vibration sensor 110. In FIG. 5B, the vertical axis represents the vibration value, and the horizontal axis represents the time.

FIG. 5C is a graph illustrating a correspondence relation between the vibration value and a total rotation angle. In FIG. 5C, the vertical axis represents the vibration value, and the horizontal axis represents the total rotation angle. The correspondence relation illustrated in FIG. 5C is derived from values of the graph illustrated in FIG. 5A and values of the graph illustrated in FIG. 5B.

For example, time points t1, t2, and t3 corresponding to predetermined total rotation numbers b1, b2, and b3 are specified with reference to the graph illustrated in FIG. 5A. Next, vibration values a1, a2, and a3 corresponding to the specified time points t1, t2, and t3 are specified with reference to the graph illustrated in FIG. 5B. Then, values illustrated in FIG. 5C are derived from the correspondence relations. The total rotation angle is derived from the total rotation number.

Here, a case where the rotational speed is temporarily zero while the rolling bearing 100 is operating is considered. For example, a timing at which the rotational frequency does not temporarily change in the total rotation number of the rolling bearing 100 as illustrated in FIG. 5A corresponds to the above case.

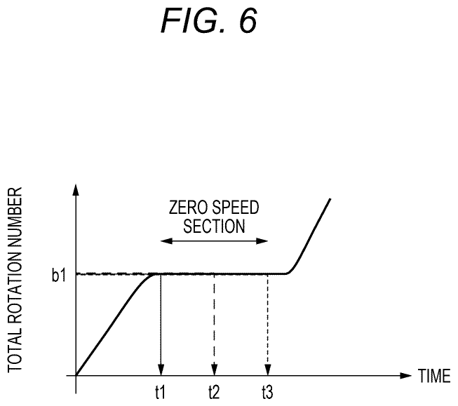

FIG. 6 is a graph focusing on the vicinity of a time point when the rotational speed is zero. In FIG. 6, the vertical axis represents the total rotation number, and the horizontal axis represents the time. In the present example, a section in which the speed is zero (hereinafter, also referred to as “zero speed section”) is included. When time at which the total rotation number b1 is obtained is referred to, all of the times t1, t2, and t3 correspond thereto. That is, the total rotation number and the time are not in a one-on-one relation. Therefore, even when the graph in FIG. 5B is referred to in order to specify the vibration value based on this value, the correspondence relation between the total rotation number and the vibration value cannot be uniquely specified. Therefore, in the zero speed section of the total rotation number, the method as illustrated in FIGS. 2A to 2D cannot be used as it is.

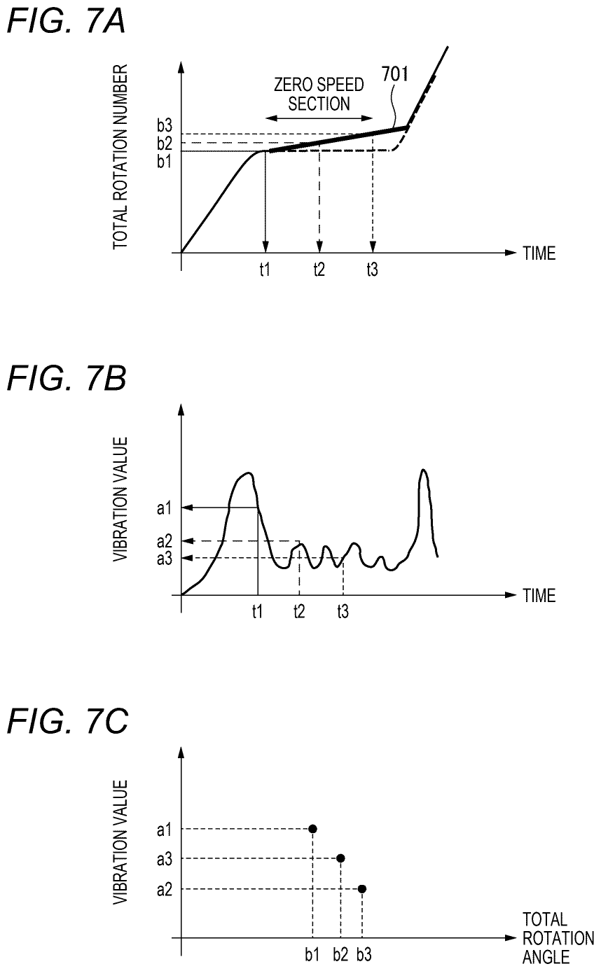

Therefore, in the present embodiment, data conversion may be performed by performing correction such that the speed changes in the zero speed section. FIGS. 7A to 7C are graphs illustrating an example of data conversion according to the present embodiment. Configurations of FIGS. 7B and 7C are the same as those of FIGS. 5B and 5C.

In FIG. 7A, the vertical axis represents the total rotation number, and the horizontal axis represents the time. In the present embodiment, first, a zero speed section is specified for the total rotation number. When there is no zero speed section, data conversion as described with reference to FIGS. 5A to 5C is performed. On the other hand, when the zero speed section is included, a time width thereof is specified. Then, correction is performed based on the time width thereof such that the total rotation number changes at a predetermined increase rate. A line 701 indicates an example of the corrected value of the total rotation number in the vicinity of the zero speed section.

As illustrated in FIG. 7A, a correction range (time) may include peripheral ranges before and after the zero speed section. An increase or decrease rate (change amount) may be defined in advance or may be changed according to a length of the zero speed section. As described above, since upsampling processing is applied before the data conversion, the increase or decrease rate may be defined based on a sampling period. In addition, the increase or decrease rate of the rotational speed in the zero speed section may be determined based on a degree of change in the rotational speed around the zero speed section. For example, when the rotational speed rapidly changes before and after the zero speed section, the increase rate may be corrected to be increased.

In the example of FIG. 7A, the correction is performed by a monotonic increase as indicated by the line 701, but the present invention is not limited thereto. For example, the increase rate of the rotational speed in a first half may be increased and the increase rate of the rotational speed in a second half may be decreased according to the time width of the zero speed section. In addition, the correction is not limited to an increase indicated by a straight line, and may be performed by an increase indicated by a curved line.

In addition, when the time width of the zero speed section exceeds a predetermined threshold, the diagnosis may be interrupted. In this case, the diagnosis may be performed separately in a period before the zero speed section occurs and a period after the zero speed section occurs. In addition, when the time width of the zero speed section exceeds a predetermined threshold, a part of the rotational speed data and the vibration data included in the period may be thinned out and used for the diagnosis processing. Accordingly, it is possible to reduce the amount of data and reduce the processing load.

In the present embodiment, the case where the rotational speed is “zero” is not necessarily limited to a state where the rolling bearing is stopped, and may include a state where the rotational speed is substantially equal to zero. A range indicated by “substantially” here may be defined in accordance with the measurement accuracy of the sensor, the sampling period, and the like.

In addition, in the present embodiment, it is sufficient that the correspondence relation between the total rotation number and the vibration value can be uniquely defined. Therefore, the correction may be omitted as long as the correspondence relation can also be uniquely specified when a point where the rotational speed is zero is included. For example, when the time of the zero speed section in which the rotational speed is zero is extremely short, it may be treated as not including the zero speed section.

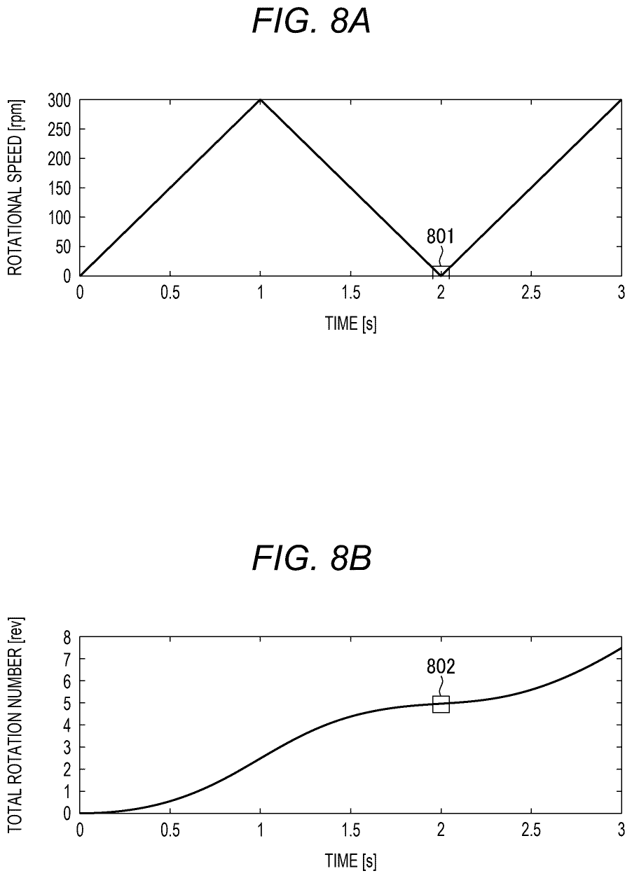

FIGS. 8A and 8B are graphs illustrating an example of the zero speed section. In FIG. 8A, the vertical axis represents the rotational speed, and the horizontal axis represents the time. In FIG. 8B, the vertical axis represents the total rotation number, and the horizontal axis represents the time. FIG. 8A corresponds to FIG. 8B. When the time is about two seconds, a zero speed section exists. The zero speed section is a section 801 in FIG. 8A, and is a section 802 in FIG. 8B. Such a zero speed section is specified, and the rotational speed is corrected as described above.

### [Test Result Example]

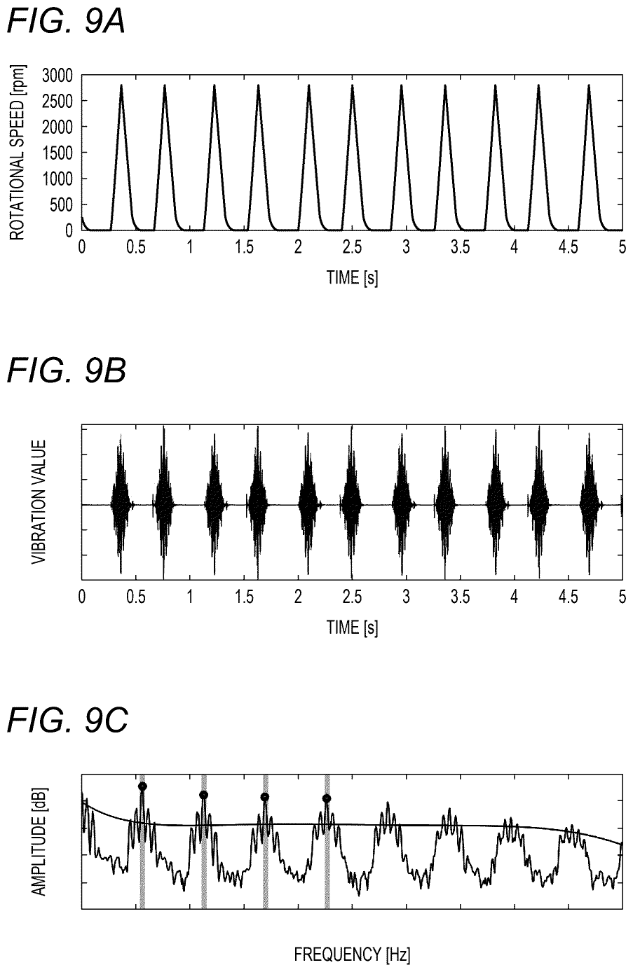

An example of a test result using the method according to the present embodiment will be described with reference to FIGS. 9A to 11C.

FIGS. 9A to 9C illustrate an example of a test result in a device in which the rotational speed rapidly changes in a short period of time, such as a direct-driven machine. FIG. 9A is a graph illustrating an example of the rotational speed acquired by the rotational speed sensor 112. In FIG. 9A, the vertical axis represents the rotational speed. The horizontal axis represents the time. FIG. 9B is a graph illustrating an example of the vibration value acquired by the vibration sensor 110. In FIG. 9B, the vertical axis represents the vibration value. The horizontal axis represents the time. As illustrated in FIG. 9A, a period in which the rotational speed is zero is included, and there is a zero speed section.

FIG. 9C illustrates a result obtained by applying the above-described correction to such detection data and executing FFT processing. In FIG. 9C, the vertical axis represents the amplitude, and the horizontal axis represents the frequency. In FIG. 9C, a hatched range indicates an example of characteristic frequencies of interest and a peripheral region of an order thereof. As indicated by circles in FIG. 9C, peaks of the frequencies can be captured, and the abnormality determination may be performed by comparing the peaks with the characteristic frequency of a portion to be subjected to abnormality diagnosis.

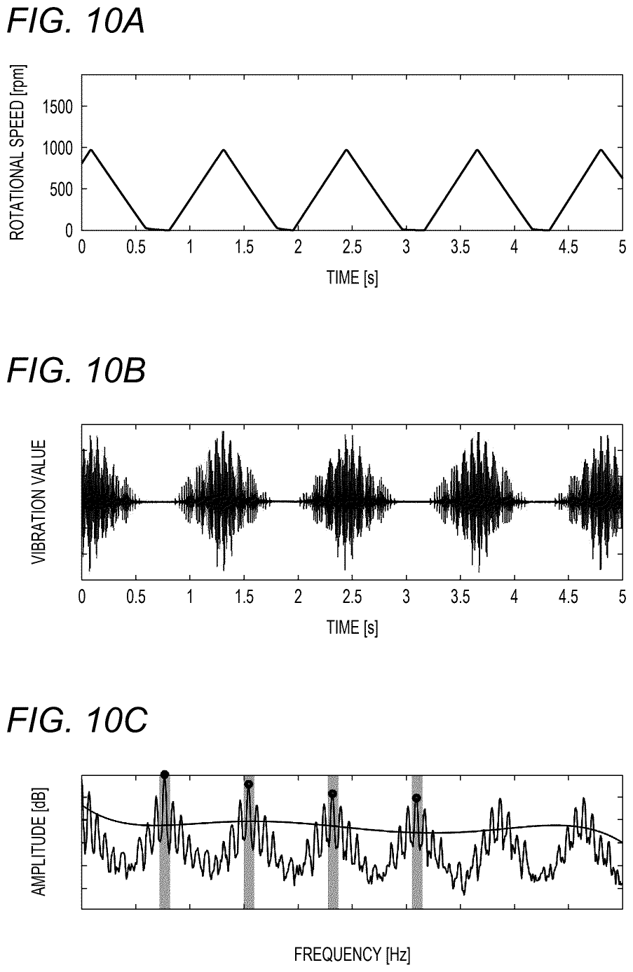

FIGS. 10A to 10C illustrate an example of a test result in a device in which the rotational speed changes at a medium degree, such as a hoisting machine. FIG. 10A is a graph illustrating an example of the rotational speed acquired by the rotational speed sensor 112. In FIG. 10A, the vertical axis represents the rotational speed. The horizontal axis represents the time. FIG. 10B is a graph illustrating an example of the vibration value acquired by the vibration sensor 110. In FIG. 10B, the vertical axis represents the vibration value. The horizontal axis represents the time. As illustrated in FIG. 10A, a period in which the rotational speed is zero is included, and there is a zero speed section.

FIG. 10C illustrates a result obtained by applying the above-described correction to such detection data and executing FFT processing. In FIG. 10C, the vertical axis represents the amplitude, and the horizontal axis represents the frequency. In FIG. 10C a hatched range indicates an example of characteristic frequencies of interest and a peripheral region of an order thereof. As indicated by circles in FIG. 10C, peaks of the frequencies can be captured, and the abnormality determination may be performed by comparing the peaks with the characteristic frequency of a portion to be subjected to abnormality diagnosis.

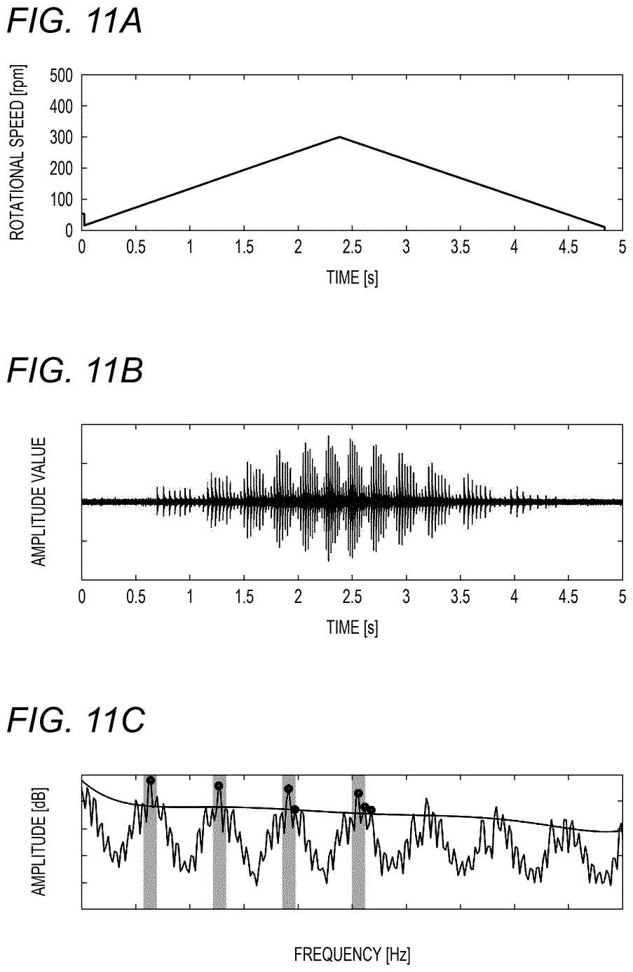

FIGS. 11A to 11C illustrate an example of a test result in a device in which the rotational speed gently changes. FIG. 11A is a graph illustrating an example of the rotational speed acquired by the rotational speed sensor 112. In FIG. 11A, the vertical axis represents the rotational speed. The horizontal axis represents the time. FIG. 11B is a graph illustrating an example of the vibration value acquired by the vibration sensor 110. In FIG. 11B, the vertical axis represents the vibration value. The horizontal axis represents the time. As illustrated in FIG. 11A, a period in which the rotational speed is zero is included, and there is a zero speed section.

FIG. 11C illustrates a result obtained by applying the above-described correction to such detection data and executing FFT processing. In FIG. 11C, the vertical axis represents the amplitude, and the horizontal axis represents the frequency. In FIG. 11C, a hatched range indicates an example of characteristic frequencies of interest and a peripheral region of an order thereof. As indicated by circles in FIG. 11C, peaks of the frequencies can be captured, and the abnormality determination may be performed by comparing the peaks with the characteristic frequency of a portion to be subjected to abnormality diagnosis.

It is also possible to appropriately capture the peak position of the frequency by the method according to the present embodiment when the rotational speed changes and a section in which the rotational speed is equal to zero is included as illustrated in FIGS. 9A to 11C. Therefore, it is possible to appropriately determine the abnormality of the device to be subjected to abnormality diagnosis.

When the abnormality determination is performed using the vibration data obtained in the present embodiment, a tendency value may be calculated based on a vibration waveform and used. In addition to the peak value (maximum value), for example, root means square (RMS), wave efficiency, kurtosis, or skewness may be used as the tendency value.

As described above, according to the present embodiment, it is possible to accurately monitor a state of a mechanical device even when a change in a rotational speed including stop of rotation occurs in an environment in which the rotational speed in a rotation operation of the mechanical device may change intermittently.

### OTHER EMBODIMENTS

In the present invention, a program or an application for implementing functions of the one or more embodiments described above may be supplied to a system or a device using a network or a storage medium, and processing in which one or more processors in a computer of the system or the device read and execute the program may be implemented.

In addition, it may be implemented by a circuit (for example, application specific integrated circuit (ASIC) or field programmable gate array (FPGA)) that implements one or more functions.

As described above, the present invention is not limited to the above-described embodiments, and combinations of the respective configurations of the embodiments and changes and modifications made by those skilled in the art based on the descriptions in the description and the well-known technique are intended by the present invention and are thus also included within the scope of the present invention to be protected.

As described above, the following matters are disclosed in the present description.

(1) A state monitoring method for a mechanical device (for example, 100) that performs a rotation operation, the state monitoring method including:
an acquisition step of acquiring rotational speed data and vibration data during the rotation operation of the mechanical device;
a conversion step of converting the vibration data from a time domain to an angle domain using the rotational speed data and the vibration data acquired in the acquisition step;
a reconversion step of reconverting the vibration data converted in the conversion step into a time domain based on a predetermined reference speed; and
a diagnosis step of diagnosing a state of the mechanical device using the vibration data converted in the reconversion step, in which
in the conversion step, when the rotational speed data includes a section in which a rotational speed is zero or substantially equal to zero, the rotational speed data is corrected such that the rotational speed fluctuates in the section, and then the vibration data is converted into an angle domain.

With this configuration, it is possible to accurately monitor the state of the mechanical device even when a change in the rotational speed including stop of rotation occurs in an environment in which the rotational speed in the rotation operation of the mechanical device may change intermittently.

(2) The state monitoring method according to (1), in which
in the conversion step, the section and a range around the section are corrected.

With this configuration, the correction is also performed on periphery of a zero speed section, so that it is possible to reduce the influence of rapid correction while maintaining consistency with the peripheral section.

(3) The state monitoring method according to (1) or (2), in which
in the conversion step, correction is performed such that the rotational speed monotonously increases in the section.

With this configuration, the rotational speed may be corrected by a simple method.

(4) The state monitoring method according to (1) or (2), in which
in the conversion step, an increase or decrease rate of the rotational speed for correction is determined according to a time width of the section.

With this configuration, it is possible to correct the rotational speed according to the time width of the zero speed section.

(5) The state monitoring method according to any of (1) to (4), in which
in the conversion step, when a time width of the section is less than a predetermined value, the vibration data is converted into an angle domain without performing the correction.

With this configuration, it is possible to perform correction according to the time width of the zero speed section.

(6) The state monitoring method according to any of (1) to (5), in which
in the diagnosis step, diagnosis is interrupted when the section is longer than a predetermined time.

With this configuration, it is possible to reduce the influence of the correction when the zero speed section is long. In particular, it is possible to prevent a decrease in accuracy of diagnosis by correction.

(7) The state monitoring method according to any of (1) to (6), in which the mechanical device is a bearing device.

With this configuration, a mechanical device including a bearing device may be applied as a diagnosis target.

(8) A state monitoring device (for example, 200) for a mechanical device (for example, 100) that performs a rotation operation, the state monitoring device including:
an acquisition unit (for example, 110, 112, and 201 to 203) configured to acquire rotational speed data and vibration data during the rotation operation of the mechanical device;
a conversion unit (for example, 202 and 203) configured to convert the vibration data from a time domain to an angle domain using the rotational speed data and the vibration data acquired by the acquisition unit;
a reconversion unit (for example, 202 and 203) configured to reconvert the vibration data converted by the conversion unit into a time domain based on a predetermined reference speed; and
a diagnosis unit (for example, 204) configured to diagnose a state of the mechanical device using the vibration data converted by the reconversion unit, in which
when the rotational speed data includes a section in which a rotational speed is zero or substantially equal to zero, the conversion unit corrects the rotational speed data such that the rotational speed fluctuates in the section, and then converts the vibration data into an angle domain.

With this configuration, it is possible to accurately monitor the state of the mechanical device even when a change in the rotational speed including stop of rotation occurs in an environment in which the rotational speed in the rotation operation of the mechanical device may change intermittently.

(9) A program that causes a computer (for example, 200) to execute:
an acquisition step of acquiring rotational speed data and vibration data during a rotation operation of a mechanical device (for example, 100);
a conversion step of converting the vibration data from a time domain to an angle domain using the rotational speed data and the vibration data acquired in the acquisition step;
a reconversion step of reconverting the vibration data converted in the conversion step into a time domain based on a predetermined reference speed; and
a diagnosis step of diagnosing a state of the mechanical device using the vibration data converted in the reconversion step, in which
in the conversion step, when the rotational speed data includes a section in which a rotational speed is zero or substantially equal to zero, the rotational speed data is corrected such that the rotational speed fluctuates in the section, and then the vibration data is converted into an angle domain.

With this configuration, it is possible to accurately monitor the state of the mechanical device even when a change in the rotational speed including stop of rotation occurs in an environment in which the rotational speed in the rotation operation of the mechanical device may change intermittently.

Although various embodiments have been described above with reference to the drawings, it is needless to mention that the present invention is not limited to these examples. It is apparent to those skilled in the art that various changes or modifications can be conceived within the scope described in the claims, and it is understood that the changes or modifications naturally fall within the technical scope of the present invention. In addition, the components described in the above embodiments may be combined in any manner without departing from the spirit of the invention.

The present application is based on a Japanese patent application (No. 2024-056324) filed on Mar. 29, 2024, contents of which are incorporated herein by reference.

### INDUSTRIAL APPLICABILITY

The present invention provides an effect of making it possible to monitor a state of a mechanical device with high accuracy even when a change in a rotational speed including stop of rotation occurs in an environment in which the rotational speed in a rotation operation of the mechanical device may intermittently change, and may be used for state monitoring of various mechanical devices including a bearing device including a bearing such as a rolling bearing.

### REFERENCE SIGNS LIST

100: rolling bearing
101: inner ring
102: rolling element
103: outer ring
104: cage
105: main shaft
110: vibration sensor
111: amplifier
112: rotational speed sensor
200: monitoring device
201: A/D conversion unit
202: data conversion unit
203: vibration signal processing unit
204: monitoring processing unit

1. A state monitoring method for a mechanical device that performs a rotation operation, the state monitoring method comprising:
an acquisition step of acquiring rotational speed data and vibration data during the rotation operation of the mechanical device;
a conversion step of converting the vibration data from a time domain to an angle domain using the rotational speed data and the vibration data acquired in the acquisition step;
a reconversion step of reconverting the vibration data converted in the conversion step into a time domain based on a predetermined reference speed; and
a diagnosis step of diagnosing a state of the mechanical device using the vibration data converted in the reconversion step, wherein
in the conversion step, when the rotational speed data includes a section in which a rotational speed is zero or substantially equal to zero, the rotational speed data is corrected such that the rotational speed fluctuates in the section, and then the vibration data is converted into an angle domain.

2. The state monitoring method according to claim 1, wherein
in the conversion step, the section and a range around the section are corrected.

3. The state monitoring method according to claim 1, wherein
in the conversion step, correction is performed such that the rotational speed monotonously increases in the section.

4. The state monitoring method according to claim 1, wherein
in the conversion step, an increase or decrease rate of the rotational speed for correction is determined according to a time width of the section.

5. The state monitoring method according to claim 1, wherein
in the conversion step, when a time width of the section is less than a predetermined value, the vibration data is converted into an angle domain without performing the correction.

6. The state monitoring method according to claim 1, wherein
in the diagnosis step, diagnosis is interrupted when the section is longer than a predetermined time.

7. The state monitoring method according to claim 1, wherein
the mechanical device is a bearing device.

8. A state monitoring device for a mechanical device that performs a rotation operation, the state monitoring device comprising:
an acquisition unit configured to acquire rotational speed data and vibration data during the rotation operation of the mechanical device;
a conversion unit configured to convert the vibration data from a time domain to an angle domain using the rotational speed data and the vibration data acquired by the acquisition unit;
a reconversion unit configured to reconvert the vibration data converted by the conversion unit into a time domain based on a predetermined reference speed; and
a diagnosis unit configured to diagnose a state of the mechanical device using the vibration data converted by the reconversion unit, wherein
when the rotational speed data includes a section in which a rotational speed is zero or substantially equal to zero, the conversion unit corrects the rotational speed data such that the rotational speed fluctuates in the section, and then converts the vibration data into an angle domain.

9. A program that causes a computer to execute:
an acquisition step of acquiring rotational speed data and vibration data during a rotation operation of a mechanical device;
a conversion step of converting the vibration data from a time domain to an angle domain using the rotational speed data and the vibration data acquired in the acquisition step;
a reconversion step of reconverting the vibration data converted in the conversion step into a time domain based on a predetermined reference speed; and
a diagnosis step of diagnosing a state of the mechanical device using the vibration data converted in the reconversion step, wherein
in the conversion step, when the rotational speed data includes a section in which a rotational speed is zero or substantially equal to zero, the rotational speed data is corrected such that the rotational speed fluctuates in the section, and then the vibration data is converted into an angle domain.
